(19) United States
(12) Patent Application Publication
(10) Pub. No.: US 2002/0040957 A1
(43) Pub. Date: Apr. 11, 2002

(54) Stabilizer apparatus for landscape light post

(76) Inventor: E. Ray Carter, Phoenix, AZ (US)

Correspondence Address: H. GORDON SHIELDS, 7830 NORTH 23RD AVENUE, PHOENIX, AZ, 85021, US

(21) Appl. No.: 10/004,361

(22) Filed: Nov. 2, 2001

Related U.S. Application Data
(63) Continuation-in-part of application No. 09/444,663, filed on Nov. 22, 1999.
Application No. 09/444,663 is a continuation-in-part of application No. 29/103,245, filed on Apr. 12, 1999.

(51) Int. Cl. F16M 13/00

(52) U.S. Cl. 248/530

(57) ABSTRACT

Stabilizer apparatus for a landscape light post includes a collar securable to a cyndrical landscape light post and stabilizer element secured to the collar. The stabilizer elements include vertically oriented elements and horizontally disposed elements. Several different embodiments are disclosed.

### CROSS REFERENCE TO RELATED APPLICATIONS

This application is a continuation-in-part of application of Ser. No. 09/444,663, filed Nov. 22, 1999, which was a continuation-in-part of application Ser. No. 29/103,245, filed Apr. 12, 1999, now patent Des. 417,293, which issued Nov. 30, 1999.

### BACKGROUND OF THE INVENTION

1. Field of the Invention

This invention relates to stabilizer elements and, more particularly, to stabilizer elements securable to a cylindrical landscape light post.

2. Description of the Prior Art

U.S. Pat. No. 4,658,877 (Carter) the inventor of which is the inventor of the present invention, discloses a landscape light post having a non-conductive cylindrical post portion and a non-conductive cap with elements in the cap for grounding a two-wire light fixture. Included in the patent are stabilizers securable to the cylindrical post. The stabilizers comprise four interlocked plates which are appropriately secured, as by a screw, to the post.

In the current application referred to above, applicant discloses collars for a cylindrical light post with stabilizer elements extending horizontally outwardly therefrom. The collar is appropriately secured to the post.

The purpose of the stabilizers is to help stabilize the landscape light post of which is under ground, as shown in the '877 (Carter) Patent. The stabilization of the light post may be advantageous when the landscape light post is disposed in loose or sandy soil.

The landscape light post stabilizer elements illustrated in the parent application are relatively easily assembled to a cylindrical landscape light post and secured thereto.

### SUMMARY OF THE INVENTION

The invention described and claimed herein comprises a collar and stabilizer fin secured to the collar. The collar is adapted to be secured to a cylindrical landscape light post. Different embodiments of stabilizers are illustrated, including stabilizers extending horizontally outward from the collar and stabilizers which are disposed vertically with respect to the collar.

Among the objects of the present invention are the following:

To provide new and useful stabilizer apparatus for a landscape light post;

To provide new and useful stabilizer elements for a landscape light post including a collar and stabilizer elements secured to the collar;

To provide new and useful stabilizer apparatus for a landscape light post including a collar and stabilizer fins secured to the collar;

To provide new and useful landscape light post stabilizer elements including vertically oriented stabilizer fins secured to a collar; and

To provide new and useful stabilizer apparatus for a light post including a collar and stabilizer fins disposed horizontally with respect to the collar.

### BRIEF DESCRIPTION OF THE DRAWING

FIG. 1 comprises a view of the apparatus of the present invention in the use environment.

FIG. 2 is a top view of the apparatus of FIG. 1.

FIGS. 3, 4, 5, and 6 are, respectively right side elevation, front elevation, rear elevation, and left side elevational views of the apparatus of FIG. 1.

FIG. 7 is a bottom view of the apparatus of FIG. 1.

FIG. 8 is a top view of an alternate embodiment of the apparatus of the present invention in its use environment.

FIG. 9 is a top view of another alternate embodiment of the apparatus of the present invention in its use environment.

FIG. 10 is a top view of another alternate embodiment of the apparatus of the present invention in its use environment.

FIG. 11 is a top view of another alternate embodiment of the apparatus of the present invention in its use environment.

FIG. 12 is a top view of another alternate embodiment of the apparatus of the present invention in its use environment.

FIG. 13 is a perspective view of another alternate embodiment of the apparatus of the present invention.

FIG. 14 is a perspective view of an alternate embodiment of the apparatus of FIG. 13.

### DESCRIPTION OF THE PREFERRED EMBODIMENT

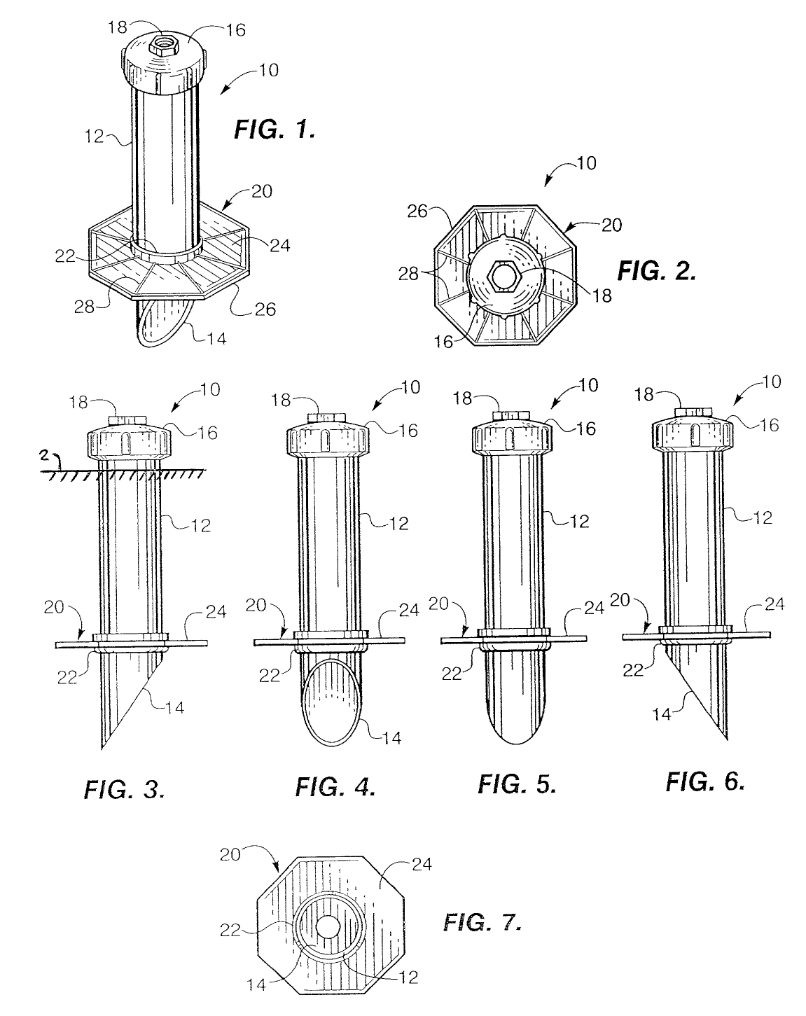

FIG. 1 is a perspective view of landscape light post apparatus including stabilizer assembly 20 of the present invention. The landscape apparatus 10 includes a generally cylindrical post 12 and a cap 16. The post 12 may have a slant cut 14 at the bottom end thereof, if desired. The cap 16 includes a bushing 18 for receiving a light fixture. The bushing 18 is internally threaded to receive the fixture (not shown).

FIG. 2 is a top view of the apparatus 10 of FIG. 1, and FIGS. 3, 4, 5, and 6 are respective right side, front, rear, and left side views of landscape light post apparatus 10. FIG. 7 is a bottom view of the apparatus of FIG. 1. For the following discussion, reference will be made to FIGS. 1-7.

Appropriately secured to the post 12 is stabilizer apparatus 20. The apparatus 20 includes a collar 22 and horizontally extending outwardly from the collar 22 is an octagonal shaped stabilizer plate 24. The stabilizer plate 24 includes an outer rim 26. The outer rim 26 is essentially an enlarged bead. The outer rim 26 is octagonally configured. That is, the outer rim has eight sides. Extending radially outwardly from the collar 22 to the rim 26 are ribs 28. The purpose of the ribs 28 and the bead or enlarged portion defining the rim 26 is to strengthen the stabilizer plate 24. The ribs 28 extend from the collar 22 to the junctures of the eight sides of the rim 26.

Ground level 2 is indicated in FIG. 3 slightly below the bottom of the cap 16. Most of the apparatus 10 is disposed in the ground, or below the ground level 2, with essentially only the cap 16, to which is secured a landscape light fixture or lamp (not shown) The fixture or lamp is secured to the internally threaded bushing 18.

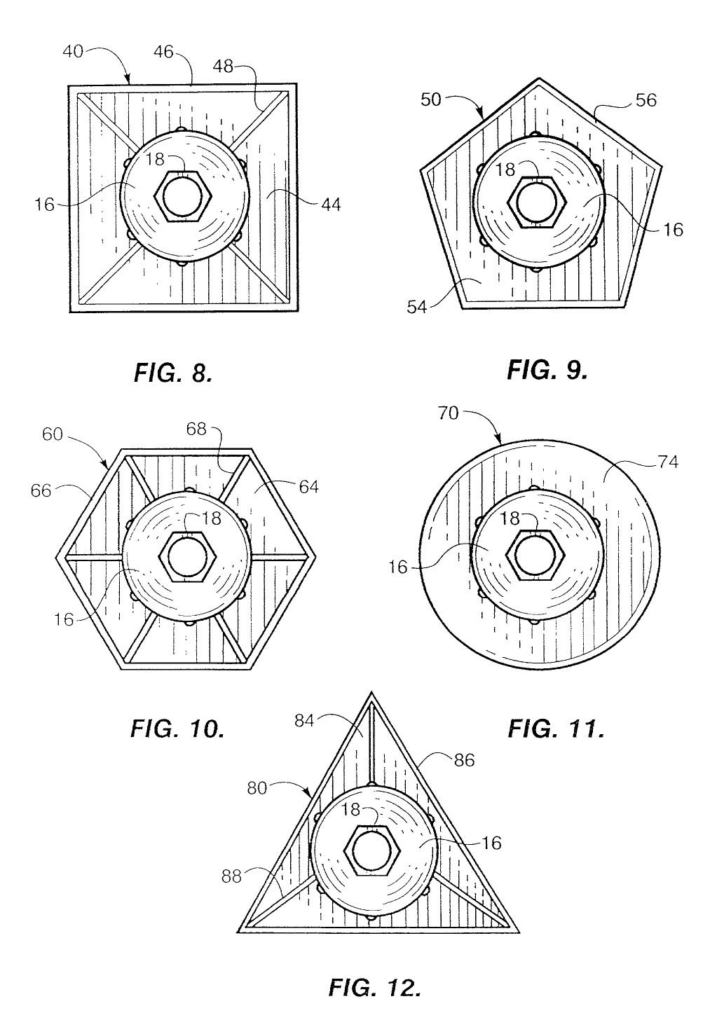

FIG. 8 comprises a top view of another alternate embodiment of the apparatus of the present invention, namely stabilizer assembly 40 secured to the post 12 (See FIGS. 1-7). In FIG. 8, the cap 16 and its bushing 18 are illustrated. The stabilizer assembly 40 again is a horizontally outwardly extending stabilizer unit, similar to the stabilizer assembly 20 of FIGS. 1-7.

The stabilizer assembly 40 comprises a generally rectangular, and specifically, a square, configuration. The stabilizer assembly 40 includes a stabilizer plate 44 with an outer rim 46. Four ribs 48 extend outwardly to the rim 46 and extend to the rim 46 at the four corners of the stabilizer plate 44. The rim 46 is an enlarged bead, as with the rim 26 of the stabilizer assembly 20. Again, the rim 46 and the ribs 48 provide stability and strength for the stabilizer plate 44. While the configuration illustrated is square, any rectangular configuration may be adapted.

A pentagonally configured stabilizer 54 is illustrated in FIG. 9. FIG. 9 comprises a top view of a stabilizer assembly 50 secured to a post (not shown, but see FIGS. 1-7). The stabilizer plate 54 in FIG. 9 is of a generally of pentagonal configuration, with a rim 56 extending about the five outer sides of the stabilizer plate 54. The rim 56 comprises an enlarged bead.

FIG. 10 is similarly a top view of a stabilizer assembly 60 secured to a post (See FIGS. 1-7). Again, only the cap 16 and its bushing 18 are shown in FIG. 10.

The stabilizer assembly 60 is a hexagonally configured assembly, with a hexagonally configured plate 64 bounded by an enlarged bead peripheral rim 66. Six ribs 68 extend outwardly from a collar (not shown, but see FIGS. 1-7) to the six corners of the plate 64, or to the junctures of the six sides of the rim 66.

FIG. 11 is a top view of a stabilizer assembly 70 which extends radially outwardly from a post (not shown, but see FIGS. 1 and 3-7) of a landscape light post assembly. Only the cap 16 and its bushing 18 is illustrated in FIG. 11, along with the generally flat or planar stabilizer assembly 70.

The stabilizer assembly 70 includes a collar (not shown) and a generally circular stabilizer plate 74. The stabilizer plate 74 may or may not require a reinforced or beaded rim, as illustrated above, and may or may not include strengthening ribs, as illustrated in the embodiments of FIGS. 1-8 and 10.

FIG. 12 comprises a top view of another stabilizer assembly, namely a triangularly configured stabilizer assembly 80. The stabilizer assembly 80 is again secured to and extends radially outwardly from a post. Again, only the cap 16 and its bushing 18 are illustrated in FIG. 12.

The stabilizer assembly 80 includes a triangularly shaped stabilizer plate 84 which extends outwardly from the post (not shown, but see FIGS. 1 and 3-7).

The triangularly shaped stabilizer plate 84 is bounded by a rim 86. Three ribs 88 extend outwardly from a collar (not shown) to the three points or side junctures of the triangular plate 84.

In the above embodiments, the stabilizer plates extend generally horizontally from their collar and from the post 12 to which they are appropriately secured. In the following embodiments, the stabilizer plates extend vertically relative to their collar.

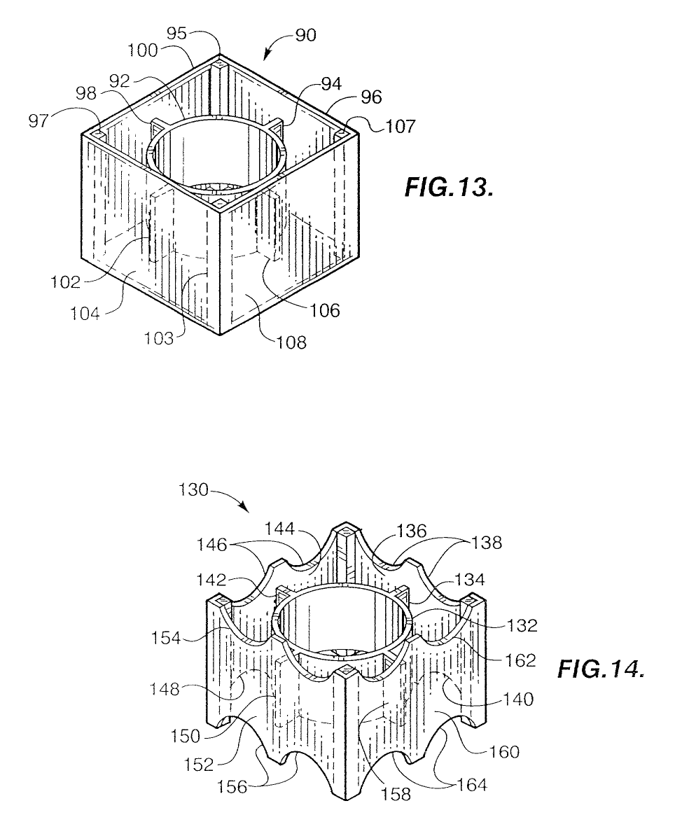

FIG. 13 is a perspective view of an alternate embodiment 90 of stabilizer apparatus of the present invention. The alternate embodiment stabilizer apparatus 90 includes a collar 92 which is generally of a cylindrical configuration to fit over, or to receive, a post, such as the post 12 illustrated above in FIGS. 1, 3, 4, 5, 6, and 7.

Extending radially outwardly from the collar 92 are four vertically or axially extending gussets to which are secured stabilizer plates. The gussets include a gusset 94 to which is secured a stabilizer plate 96. A second gusset 98 extends radially outwardly from the collar 92, and a stabilizer plate 100 is secured to the gusset 98. A third gusset 102 extends radially outwardly from a collar 92 generally aligned with the gusset 94. A stabilizer plate 104 is secured to the gusset 102. Finally, a fourth gusset 106 extends radially outwardly from the collar 92 diametrically aligned with the collar 98. A stabilizer plate 108 is secured to the gusset 106.

The stabilizer plates 96, 100, 104, and 108 are generally of a rectangular configuration and they are appropriately secured to each other at their outer ends. Thus, the four stabilizer plates define a closed rectangular box open at the top and at the bottom, with the collar 92 centrally located within the box defined by the four stabilizer plates. The “box” is secured to the post by the four radially extending gussets 94, 98, 102, and 106.

The stabilizer plates 96, 100, 104, and 108 extend generally parallel to the longitudinal axis of the collar 92, and accordingly generally parallel to the vertical or longitudinal axis of the post to which they are secured through their collar 92.

For structural integrity, four corner braces 95, 97, 103, and 107 are shown at the junctures of the respective stabilizer plates 96 and 100, 100 and 104, 104 and 108, and 108 and 96. The corner braces may or may not be necessary, depending on the thickness of the material out of which the apparatus is made. Preferably, polyvinyl chloride (PVC) may be used in the fabrication of the apparatus of the present invention. PVC is very durable, and will not degrade in the ground. PVC also has substantial strength. Assuming substantial thickness, the ribs of the stabilizer assemblies 10, 40, 60, and 80 may not be needed for reinforcing strength, and the beaded outer rims of the embodiments of FIGS. 1-12 may also not be needed for reinforcing strength. Moreover, the reinforcing corner braces of the stabilizer assembly 90 of FIGS. 13 and 14 may not be needed.

FIG. 14 is a perspective view of stabilizer assembly 130 which comprises an alternate embodiment of the stabilizer apparatus 90. The stabilizer apparatus 130 includes scalloped portions at the tops and bottoms of the four stabilizer plates. The apparatus 130 includes a collar 132 with four gussets extending vertically on the outer periphery of the collar 132. The gussets a gusset 134, a gusset 142, a gusset 150, and a gusset 158. The gussets 134 and 150 are diametrically opposite to each other and the gussets 142 and 158 are diametrically opposite to each other.

A stabilizer plate 136 is secured to the gusset 134, a stabilizer plate 144 is secured to the gusset 142, a stabilizer plate 152 is secured to the gusset 150, and a stabilizer plate 160 is secured to the gusset 158. The four stabilizer plates are secured to each other at their corners. This is also substantially the same general design as the stabilizer assembly 90 of FIG. 13. However, a decorative touch has been applied to the stabilizer apparatus 130.

The stabilizer plate 136 includes a pair of upper or top scallops 138 and a pair of bottom or lower scallops 140. The stabilizer plate 144 includes a pair of upper scallops 146 and a pair of lower scallops 148. It will be noted that only a single scallop 140 and 148 are shown for the stabilizer plates 136 and 144. However, the stabilizer plates 152 and 160 clearly show two pair of scallops. For the stabilizer plate 152, there are two upper scallops 154 and two lower scallops 156, and the stabilizer plate 160 includes two upper scallops 162 and two lower scallops 164. Again, corner braces are shown for the stabilizer assembly 130 just as for the stabilizer assembly 90.

It will be noted that the decorative scallops in the assembly 130 simply provide an aesthetic appeal as compared to the rather drab generally rectangular stabilizer assembly 90. However, the function is obviously substantially identical.

It will be noted that the length or height of a collar may vary, as illustrated for the various embodiments. The horizontal stabilizer plates generally require the shortest collars, while the vertical stabilizer plates generally require the longest collars.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, within the limits only of the true spirit and scope of the invention.

What I claim is:

1. Stabilizer apparatus for a landscape light post comprising in combination:
a collar to be secured to the post and disposed under ground;
stabilizer plate means secured to the collar for stabilizing the post under ground.

2. The apparatus of claim 1 in which the stabilizer plate means extends radially outwardly from the collar.

3. The apparatus of claim 1 in which the stabilizer plate means extends generally vertically.

4. The apparatus of claim 3 in which the stabilizer plate means includes a plurality of stabilizer plates spaced apart from the collar.

5. The apparatus of claim 1 in which the stabilizer plate means extends generally horizontally outwardly from the collar.

6. The apparatus of claim 5 in which the stabilizer plate means has a generally circular configuration.

7. The apparatus of claim 5 in which the stabilizer plate means has a generally rectangular configuration.

8. The apparatus of claim 5 in which the stabilizer plate means includes an outer rim having a plurality of sides.

9. The apparatus of claim 1 in which the stabilizer plate means includes gussets secured to the collar and stabilizer plates secured to the gussets.

10. The apparatus of claim 9 in which the stabilizer plates are disposed generally vertically.

11. The apparatus of claim 10 in which the stabilizer plates are secured to each other to define corners spaced apart from the collar.

12. The apparatus of claim 1 in which the stabilizer plate means includes a box secured to the post.

13. The apparatus of claim 12 in which the stabilizer plate means further includes gussets secured to the box and to the post for securing the box to the post.
